(19) United States
(12) Patent Application Publication
(10) Pub. No.: US 2012/0278130 A1
(43) Pub. Date: Nov. 1, 2012

(54) MOBILE TRAFFIC FORECASTING USING PUBLIC TRANSPORTATION INFORMATION

(75) Inventor: Seungil Kim, Seoul (KR)

(73) Assignee: EMPIRE TECHNOLOGY DEVELOPMENT LLC, Wilmington, DE (US)

(21) Appl. No.: 13/201,258

(22) PCT Filed: Apr. 28, 2011
(86) PCT No.: PCT/US11/34382

§ 371 Date: Aug. 12, 2011

(51) Int. Cl. G06Q 10/00

(52) U.S. Cl. 705/7.31

(57) ABSTRACT

Technologies are generally described for mobile traffic forecasting using public transportation information. In some examples, a method performed under the control of a mobile traffic forecasting system may include receiving payment information of a public transportation, and estimating mobile traffic for one or more base stations on a route of the public transportation based on the payment information of the public transportation.

### BACKGROUND

In mobile telecommunications, many mobile users moving at the same time by a public transportation such as a bus or a subway may affect the mobile traffics. Especially in the rush hour when there are many people on move, such an effect can be tremendous. In this regard, in order to improve service quality of the mobile network, it is necessary to forecast the mobile traffics on the route of public transportation to manage resource reservation.

### SUMMARY

In an example, a method performed under the control of a mobile traffic forecasting system may include receiving payment information of a public transportation, and estimating mobile traffic for one or more base stations on a route of the public transportation based on the payment information of the public transportation.

In an example, a mobile traffic forecasting system may include passenger counting unit configured to count number of passengers of a public transportation based on payment information of the public transportation, and mobile traffic estimation unit configured to estimate mobile traffic for one or more base stations on a route of the public transportation based on the number of passengers counted by the passenger counting unit.

In an example, a computer-readable storage medium may have contents, when executed by a processor, causing the processor to receive payment information of a public transportation, and estimate mobile traffic for one or more base stations on a route of the public transportation based on the payment information of the public transportation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an illustrative example of an environment where cell transition occurs on a route of a public transportation;

FIG. 2 schematically shows an illustrative example of an environment where a mobile traffic forecasting system is employed for forecasting mobile traffic on a route of a public transportation;

FIG. 3 shows a schematic diagram illustrating an example mobile traffic forecasting system;

FIG. 4 shows an example flow diagram of a process for mobile traffic forecasting; and

FIG. 5 shows an example flow diagram of another process for mobile traffic forecasting,

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products related to mobile traffic forecasting using public transportation information.

Briefly stated, technologies are generally described for forecasting mobile traffic on a route of a public transportation. In some examples, a mobile traffic forecasting system may receive payment information of the public transportation, count number of passengers based on the payment information, and estimate the mobile traffic for one or more base stations on the route of the public transportation based on the received payment information and/or statistical information such as statistical passenger information on number of passengers for the public transportation and statistical traffic information on the route of the public transportation.

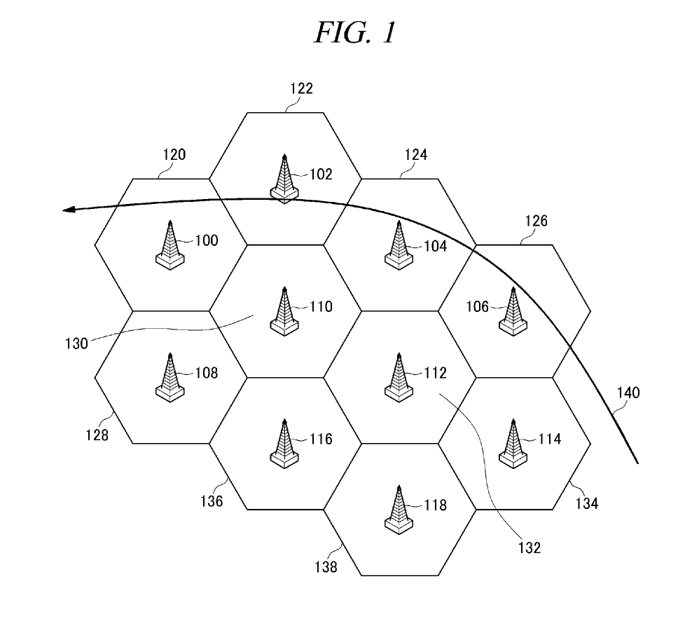

FIG. 1 schematically shows an illustrative example of an environment where cell transition occurs on a route of a public transportation arranged in accordance with at least some embodiments described herein. A mobile service provider may provide users with mobile service via base stations 100, 102, 104, 106, 108, 110, 112, 114, 116 and 118. Base stations 100, 102, 104, 106, 108, 110, 112, 114, 116 and 118 may define cells 120, 122, 124, 126, 128, 130, 132, 134, 136 and 138, respectively. Each of the cells may correspond to the service range provided by each of the base stations.

A public transportation may move along a predetermined route 140. Examples of public transportation include, but are not limited to, a bus, a tram, a train, a subway, a ferry and a water bus.

In some embodiments, in cases where the public transportation containing a certain number of passengers moves from station P to station Q along route 140, as depicted in FIG. 1, active mobile users, who are using the mobile network, on the public transportation may experience cell transition from cell 126 to cell 124, from cell 124 to cell 122, and from cell 122 to cell 120, successively. In some embodiments, the mobile service provider may know number of passengers at station P, i.e., in cell 126, based on payment information of the public transportation. The mobile service provider may also know number of active users who are currently using the mobile network, and number of possible users who are not currently using the mobile network, at station P, i.e., in cell 126. The mobile service provider may know the exact number of active users and/or the exact number of possible users. Alternatively, the mobile service provide may know the approximate number of active users and/or the approximate number of possible users.

Considering traffic information, such as, for example, travel time to the next station, i.e., station Q, the mobile service provider may estimate when the passengers and/or the active users enter cells 124, 122 and 120. Based thereon, the mobile service provider may estimate the timing and the volume of the mobile traffic associated with the active users to be added to cells 124, 122 and 120. In some embodiments, real-time traffic information may be combined to provide more accurate estimation of the mobile traffic. In such cases, the mobile service provider may estimate more accurately on when the public transportation may enter the respective cells.

In some embodiments, the mobile service provider may estimate the mobile traffic not only for the nearby cells, but also for the distant cells. To estimate the mobile traffic for the distant cells, the mobile service provider may utilize statistical information. By way of example, but not limitation, the mobile service provider may estimate the mobile traffic for the base stations on the route of the public transportation based on statistical passenger information on number of passengers for the public transportation. By way of example, but not limitation, the statistical passenger information may include number of passengers getting onto the public transportation for respective stations and for respective times, number of passengers getting off the public transportation for the respective stations and for the respective times, and ratio between number of active users and total number of the passengers for the respective stations and for the respective times.

In some embodiments, the mobile service provider may revise the estimated mobile traffic based on real-time information on the number of passengers for the public transportation. By way of example, but not limitation, the real-time information on the number of passengers for the public transportation may include the number of active users at respective cells.

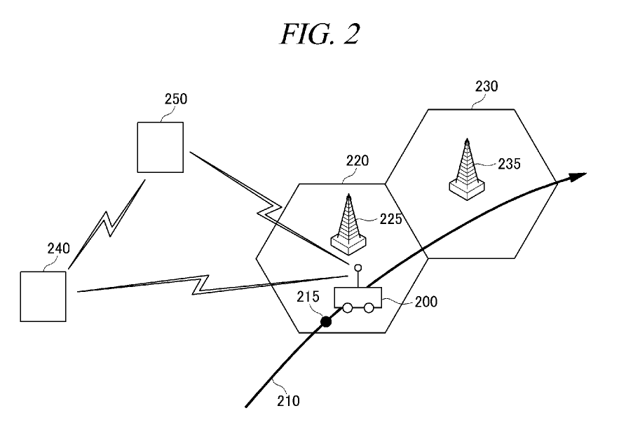

FIG. 2 schematically shows an illustrative example of an environment where a mobile traffic forecasting system is employed for forecasting mobile traffic on a route of a public transportation arranged in accordance with at least some embodiments described herein. In the example illustrated in FIG. 2, a public transportation 200 moves along a predetermined route 210, on which a station 215 exists. Public transportation 200 is configured to pass through multiple cells including a cell 220 and a cell 230. Cells 220 and 230 are respectively served by base stations 225 and 235. Station 215 is located at cell 220.

When one or more passengers get onto and/or off public transportation 200 at station 215, the passengers may pay transportation fees. By way of example, but not limitation, the transportation fees may be paid by utilizing a mobile payment system, such as, for example, near field communication (NFC) mobile payment system, or by utilizing a card payment system, such as, for example, a credit card system, a smart card system, or a transportation card system. In such cases, the passengers may pay the transportation fees by tagging their mobile devices or cards onto a payment terminal (not shown). By way of example, but not limitation, the payment terminal (not shown) may be installed or located in public transportation 200 or at station 215.

In some embodiments, the payment terminal may send payment information of public transportation 200 to a mobile traffic forecasting system 240. In some embodiments, the payment terminal may send payment information of public transportation 200 to a payment agent 250, such as, for example, a credit card company, and the payment agent may then send the payment information to mobile traffic forecasting system 240.

After receiving payment information of public transportation 200, mobile traffic forecasting system 240 may estimate mobile traffic to be flowed into the next cell on route 210, i.e., cell 230, based on the received payment information.

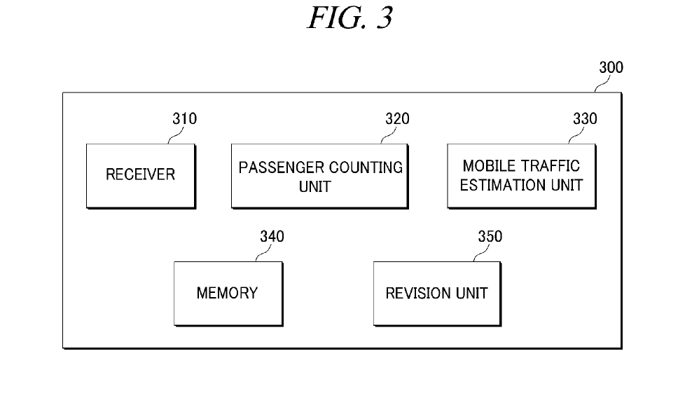

FIG. 3 shows a schematic diagram illustrating an example mobile traffic forecasting system arranged in accordance with at least some embodiments described herein. As depicted, a mobile traffic forecasting system 300 may include a receiver 310, a passenger counting unit 320, a mobile traffic estimation unit 330, a memory 340 and a revision unit 350. Although illustrated as discrete components, various components may be divided into additional components, combined into fewer components, or eliminated, depending on the desired implementation.

Receiver 310 may be configured to receive payment information from a public transportation. In some embodiments, the payment information may include identification information on a mobile device of a passenger of the public transportation. In such cases, based on the payment information received by receiver 310, mobile traffic forecasting system 300 may identify, at a certain station, who are on the public transportation based on the identification information. In some embodiments, the payment information may be provided by a mobile payment system, such as, for example, near field communication (NFC) mobile payment system. In some embodiments, the payment information may be provided by a card payment system, such as, for example, a credit card system, a smart card system, or a transportation card system.

Passenger counting unit 320 may be configured to count number of passengers of the public transportation based on the payment information received by receiver 310. In some embodiments, passenger counting unit 320 may identify number of passengers getting onto the public transportation for respective stations and number of passengers getting off the public transportation for the respective stations, and count the total number of passengers of the public transportation based on the number of passengers getting onto the public transportation and the number of passengers getting off the public transportation.

Mobile traffic estimation unit 330 may be configured to estimate mobile traffic for one or more base stations on a route of the public transportation based on the number of passengers counted by passenger counting unit 320.

In some embodiments, mobile traffic estimation unit 330 may estimate the mobile traffic based on traffic information on the route of the public transportation. By way of example, but not limitation, the traffic information may include a route map of the public transportation and statistical traffic information on the route of the public transportation. By way of example, but not limitation, the statistical traffic information may include time taken to travel to the next station for respective stations and for respective times.

In some embodiments, mobile traffic estimation unit 330 may estimate the mobile traffic, further based on statistical passenger information. By way of example, but not limitation, the statistical passenger information may include number of passengers getting onto the public transportation for respective stations and for respective times, number of passengers getting off the public transportation for the respective stations and for the respective times, and ratio between number of active users and the total number of the passengers for the respective stations and for the respective times.

Memory 340 may be configured to store statistical information including the statistical passenger information on number of passengers for the public transportation and the statistical traffic information on the route of the public transportation. In some embodiments, the statistical passenger information and the statistical traffic information stored in memory 340 may be updated by real-time passenger information on the number of passengers for the public transportation and real-time traffic information on the route of the public transportation, respectively.

Revision unit 350 may be configured to revise the mobile traffic estimated by mobile traffic estimation unit 330, based on real-time information on the number of passengers for the public transportation. In some embodiments, revision unit 350 may revise the estimated mobile traffic based on the actual number of active users.

In some embodiments, the estimated mobile traffic may be employed in cell design, resource reservation management, hand-over management, load balancing, various sorts of simulations, and so on.

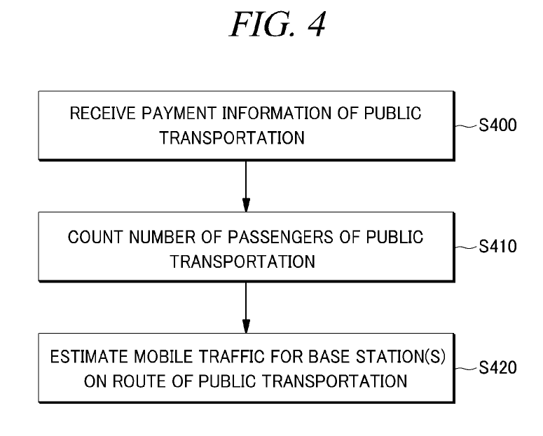

FIG. 4 shows an example flow diagram of a process for mobile traffic forecasting arranged in accordance with at least some embodiments described herein. The process in FIG. 4 may be implemented using, for example, the mobile traffic forecasting system discussed above. An example process may include one or more operations, actions, or functions as illustrated by one or more of blocks S400, S410, and/or S420. Although illustrated as discrete blocks, various blocks may be divided into additional blocks, combined into fewer blocks, or eliminated, depending on the desired implementation. Processing may begin at block S400.

At block S400, a mobile traffic forecasting system may receive payment information of a public transportation. By way of example, but not limitation, a receiver in the mobile traffic forecasting system may receive the payment information from the public transportation. In some embodiments, the payment information may include identification information on a mobile device of a passenger of the public transportation. In some embodiments, the payment information may be provided by a mobile payment system, such as, for example, near field communication (NFC) mobile payment system, or by a card payment system, such as, for example, a credit card system, a smart card system, or a transportation card system. Processing may continue from block S400 to block S410.

At block S410, the mobile traffic forecasting system may count number of passengers based on the received payment information of the public transportation. By way of example, but not limitation, a passenger counting unit in the mobile traffic forecasting system may count the number of passengers. In some embodiments, the mobile traffic forecasting system may identify number of passengers getting onto the public transportation for respective stations and number of passengers getting off the public transportation for the respective stations, and count the total number of passengers of the public transportation based thereon. Processing may continue from block S410 to block S420.

At block S420, the mobile traffic forecasting system may estimate mobile traffic for one or more base stations on a route of the public transportation based on the payment information of the public transportation. By way of example, but not limitation, a mobile traffic estimation unit in the mobile traffic forecasting system may estimate the mobile traffic. In some embodiments, the mobile traffic forecasting system may estimate the mobile traffic based on at least one of statistical traffic information, real-time traffic information, statistical passenger information and real-time passenger information. By way of example, but not limitation, the statistical traffic information may include statistical information on time taken to travel to the next station for respective stations and for respective times. By way of example, but not limitation, the statistical passenger information may include statistical information on number of passengers getting onto the public transportation for the respective stations and for the respective times, statistical information on number of passengers getting off the public transportation for the respective stations and for the respective times, and statistical information on ratio between number of active users and total number of the passengers for the respective stations and for the respective times.

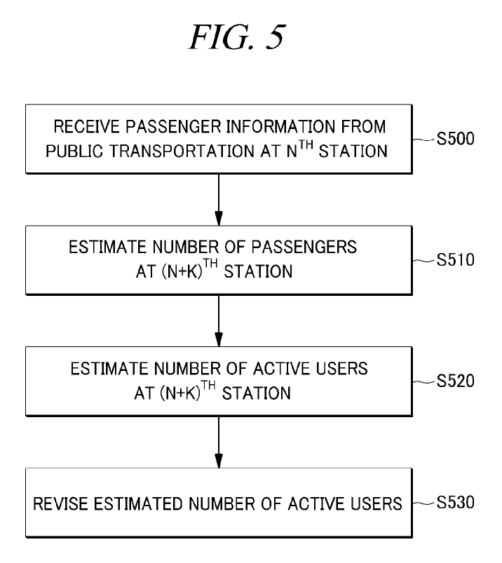

FIG. 5 shows an example flow diagram of another process for mobile traffic forecasting arranged in accordance with at least some embodiments described herein. Specifically, FIG. 5 illustrates an example process for estimating mobile traffic of (n+k)^{th} station from the reference of n^{th} station. The process in FIG. 5 may be implemented using, for example, the mobile traffic forecasting system discussed above. An example process may include one or more operations, actions, or functions as illustrated by one or more of blocks S500, S510, S520 and/or S530. Although illustrated as discrete blocks, various blocks may be divided into additional blocks, combined into fewer blocks, or eliminated, depending on the desired implementation.

In the example embodiments described with reference to FIG. 5, the mobile traffic forecasting system may hold or have statistical traffic information and statistical passenger information in a memory in the mobile traffic forecasting system and/or access to statistical traffic information and statistical passenger information stored in an external memory. By way of example, but not limitation, the statistical traffic information may include statistical information on time taken to travel to the next station for respective stations and for respective times. By way of example, but not limitation, the statistical passenger information may include at least one of statistical information on number of passengers getting onto the public transportation for the respective stations and for the respective times, statistical information on ratio between the number of passengers getting onto the public transportation and total number of the passengers for the respective stations and for the respective times, statistical information on number of passengers getting off the public transportation for the respective stations and for the respective times, statistical information on ratio between the number of passengers getting off the public transportation and the total number of the passengers for the respective stations and for the respective times, and statistical information on ratio between number of active users and the total number of the passengers for the respective stations and for the respective times. In the example embodiments below, xₙ denotes n^{th} station of the public transportation, tₙ denotes the time when the public transportation passes through the n^{th} station, N(xₙ, tₙ) denotes the number of passengers on the public transportation at the n^{th} station at time tₙ, Nᵢ(xₙ, tₙ) denotes the number of passengers getting onto the public transportation at the n^{th} station at time tₙ, pᵢ(xₙ, tₙ) denotes the probability of passengers getting onto the public transportation at the n^{th} station at time tₙ, Nₒ(xₙ, tₙ) denotes the number of passengers getting off the public transportation at the n^{th} station at time tₙ, pₒ(xₙ, tₙ) denotes the probability of passengers getting off the public transportation at the n^{th} station at time tₙ, N_{A}(xₙ, tₙ) denotes the number of active users at the n^{th} station at time tₙ, and p_{A}(xₙ, tₙ) denotes the ratio between the number of active users and the total number of the passengers at the n^{th} station at time tₙ.

Processing may begin at block S500. At the n^{th} station at time tₙ, the mobile traffic forecasting system may receive from the public transportation passenger information including the number of passengers getting onto the public transportation, i.e., Nᵢ(xₙ, tₙ), the number of passengers getting off the public transportation, i.e., Nₒ(xₙ, tₙ), and the number of active users, i.e., N_{A}(xₙ, tₙ).

At block S510, the mobile traffic forecasting system may estimate number of passengers at (n+k)^{th} station at time tₙ₊ₖ, i.e., \hat{N}(xₙ₊ₖ, tₙ₊ₖ) based on the statistical passenger information. By way of example, but not limitation, the number of passengers at (n+k)^{th} station at time tₙ₊ₖ may be estimated as follows:

$$\hat{N} ( {x}_{n + k} , {t}_{n + k} ) = N ( {x}_{n} , {t}_{n} ) {\prod }_{l = 1}^{k} ( 1 + {p}_{i} ( {x}_{n + l} , {t}_{n + l} ) - {p}_{o} ( {x}_{n + l} , {t}_{n + l} ) )$$

At block S520, the mobile traffic forecasting system may estimate number of active users at (n+k)^{th} station at time tₙ₊ₖ, i.e., \hat{N}\hat{N_{A}}(xₙ₊ₖ,tₙ₊ₖ) based on the statistical passenger information. By way of example, but not limitation, the number of the active users at (n+k)^{th} station at time tₙ₊ₖ may be estimated as follows:

\hat{N_{A}}(xₙ₊ₖ,tₙ₊ₖ)=\hat{N}(xₙ₊ₖ,tₙ₊ₖ)p_{A}(xₙ₊ₖ,tₙ₊ₖ)

At block S530, the mobile traffic forecasting system may revise the estimated number of active users more accurately based on the actually detected number of active users at the n^{th} station at time tₙ, i.e., N_{A}(xₙ, tₙ). By way of example, but not limitation, the number of active users may be revised as follows:

$$\hat{{N}_{A}} ( {x}_{n + k} , {t}_{n + k} ) = \hat{N} ( {x}_{n + k} , {t}_{n + k} ) {p}_{A} ( {x}_{n + k} , {t}_{n + k} ) \frac{1}{{p}_{A} ( {x}_{n} , {t}_{n} )} \frac{{N}_{A} ( {x}_{n} , {t}_{n} )}{N ( {x}_{n} , {t}_{n} )}$$

The number of active users estimated through the example processes described with reference to FIGS. 4-5 may be an index or indicator of the mobile traffic. In some embodiments, the estimated number of active users may be employed in cell design, resource reservation management, hand-over management, load balancing, various sorts of simulations, and so on.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under the control of a mobile traffic forecasting system, the method comprising:
receiving payment information of a transportation fee for a plurality of passengers to access a public transportation unit; and
estimating, by a processor, mobile communication traffic for each of a plurality of base stations spaced along a route of the public transportation unit based on the payment information of the public transportation unit, the plurality of base stations configured to receive and transmit wireless communications in a mobile communications network and the mobile communication traffic being between mobile devices on the public transportation unit and the plurality of base stations.

2. The method of claim 1, wherein the payment information comprises identification information on one of the mobile devices of one of the plurality of passengers of the public transportation unit.

3. The method of claim 1, wherein the payment information is provided by a mobile payment system.

4. The method of claim 1, further comprising:
counting a number of passengers based on the payment information of the public transportation unit.

5. The method of claim 1, wherein the estimating is further based on traffic information on the route of the public transportation unit.

6. The method of claim 1, wherein the estimating is further based on statistical passenger information on a number of passengers for the public transportation unit.

7. The method of claim 6, wherein the statistical passenger information comprises at least one of a number of passengers getting onto the public transportation unit for respective stations and for respective times, a number of passengers getting off the public transportation unit for the respective stations and for the respective times, and a ratio between a number of active users and a total number of the passengers for the respective stations and for the respective times.

8. The method of claim 6, further comprising:
revising the estimated mobile communication traffic based on real-time information on the number of passengers for the public transportation unit.

9. The method of claim 8, wherein the real-time information on the number of passengers for the public transportation unit comprises the number of active users.

10. A mobile traffic forecasting system comprising:
a passenger counting unit configured to count a number of passengers of a public transportation based on payment information of a transportation fee for the passengers to access the public transportation; and
a mobile communication traffic estimation unit, comprising a processor, configured to estimate mobile communication traffic for each of a plurality of base stations spaced along a route of the public transportation based on the number of passengers counted by the passenger counting unit, the plurality of base stations configured to receive and transmit wireless communications in a mobile communications network and the mobile communication traffic being between mobile devices on the public transportation unit and the plurality of base stations.

11. The mobile traffic forecasting system of claim 10, wherein the payment information comprises identification information on one of the mobile devices of one of the passengers of the public transportation.

12. The mobile traffic forecasting system of claim 10, wherein the payment information is provided by a mobile payment system.

13. The mobile traffic forecasting system of claim 10, wherein the mobile communication traffic estimation unit is further configured to estimate the mobile communication traffic based on traffic information on the route of the public transportation.

14. The mobile traffic forecasting system of claim 10, further comprising:
a memory configured to store statistical information comprising at least one of statistical passenger information on a number of passengers for the public transportation and statistical traffic information on the route of the public transportation.

15. The mobile traffic forecasting system of claim 14, wherein the statistical passenger information and the statistical traffic information stored in the memory are updated by real-time information on the number of passengers for the public transportation and real-time information on the route of the public transportation, respectively.

16. The mobile traffic forecasting system of claim 14, wherein the mobile communication traffic estimation unit is further configured to estimate the mobile communication traffic based on at least one of the statistical passenger information and the statistical traffic information.

17. The mobile traffic forecasting system of claim 16, wherein the statistical passenger information comprises at least one of a number of passengers getting onto the public transportation for respective stations and for respective times, a number of passengers getting off the public transportation for the respective stations and for the respective times, and a ratio between a number of active users and a total number of the passengers for the respective stations and for the respective times.

18. The mobile traffic forecasting system of claim 16, further comprising:
revision unit configured to revise the mobile communication traffic estimated by the mobile communication traffic estimation unit, based on real-time information on the number of passengers for the public transportation.

19. The mobile traffic forecasting system of claim 18, wherein the real-time information on the number of passengers for the public transportation comprises the number of active users.

20. A computer-readable storage medium whose contents, when executed by a processor, cause the processor to:
receive payment information of a transportation fee for a plurality of passengers to access a public transportation unit; and
estimate mobile communication traffic for each of a plurality of base stations spaced along a route of the public transportation unit based on the payment information of the public transportation unit, the plurality of base stations configured to receive and transmit wireless communications in a mobile communications network and the mobile communication traffic being between mobile devices on the public transportation unit and the plurality of base stations.
